(19) United States
(12) Patent Application Publication
(10) Pub. No.: US 2010/0183256 A1
(43) Pub. Date: Jul. 22, 2010

(54) ANGULAR BALL BEARING

(75) Inventors: Keisuke Kimura, Kanagawa (JP); Mikiko Shirai, Kanagawa (JP); Teruaki Ootani, Kanagawa (JP)

Correspondence Address: SUGHRUE-265550, 2100 PENNSYLVANIA AVE. NW, WASHINGTON, DC, 20037-3213, US

(73) Assignee: NSK LTD., Tokyo (JP)

(21) Appl. No.: 12/067,228

(22) PCT Filed: Aug. 24, 2007
(86) PCT No.: PCT/JP2007/209308

§ 371 Date: Mar. 18, 2008

(30) Foreign Application Priority Data
Aug. 25, 2006 (JP) 2006-228725
Aug. 10, 2007 (JP) 2007-209308

(51) Int. Cl. F16C 33/38

(52) U.S. Cl. 384/523

(57) ABSTRACT

When an outer diameter of an outer ring 4 is designated as D, an inner diameter of an inner ring 2 is designated as d, and a pitch circle diameter of respective balls 6 is designated as dm, a relationship of ((D+d)/2×0.85≦dm≦(D+d)/2×0.97 is satisfied. Further, when a diameter of the respective balls 6 is designated as Da, a axial width of a ball bearing is designated as B, a distance between centers of respective adjacent balls 6 in a circumferential direction is designated as L, and a sectional height of the ball bearing calculated by a relationship of H=(D−d)/2 is designated as H, all of relationships of 0.60≦Da/H≦0.75, and 0.58≦Da/B≦0.85, and 1.03Da≦L≦1.25Da are satisfied. Thereby, a structure capable of reducing rotational torque is realized without sacrificing durability.

### TECHNICAL FIELD

The present invention relates to an improvement in an angular ball bearing. Particularly, there is realized an angular ball bearing having a high load capacity and a low rotational torque suitable for supporting a rotating shaft of an industrial machine, for example, various kinds of mechanical apparatus of a pump apparatus and a compressor apparatus.

### RELATED ART

Conventionally, there are known various rolling bearings for rotatably supporting a predetermined rotating shaft, for example, in a case of a ball bearing using a ball as a rolling element, various kinds of types of ball bearings of a deep groove ball bearing, a self-aligning ball bearing and an angular type ball bearing and the like are reduced into practice. Among them, an angular type ball bearing can be loaded with both a radial load and an axial load by a single piece of the ball bearing, and therefore, the angular type ball bearing is widely used as the rolling bearing for supporting rotating shafts of various kinds of mechanical apparatus of, for example, a pump apparatus, a compressor apparatus and the like.

As shown by FIG. 7, such an angular type ball bearing (hereinafter, there is also a case of being referred to simply as ball bearing) includes a pair of raceway rings (inner ring 20 and outer ring 40) arranged concentrically with each other and opposedly to each other relatively rotatably and a plurality of balls 60 rotatably disposed between the two raceway rings (inner ring 20 and outer ring 40). The respective balls 60 are respectively disposed between the two raceway rings 20 and 40 in a state of setting an angle of contact a of respectives to about 15° through 40°. The angle of contact α refers to an angle made by an action line connecting two points (center points of contact ellipses formed at rolling contact portions) at which rolling faces of the respective balls 60 are respectively brought into rolling contact with an inner ring raceway 20a formed at an outer peripheral face of the inner ring 20 and an outer ring raceway 40a formed at an inner peripheral face of the outer ring 40, and a plane orthogonal to a center axis of the ball bearing (radial plane).

Further, the respective balls 60 are disposed between the inner ring raceway 20a and the outer ring raceway 40a in a state of being retained in pockets 80p provided at a cage 80 at respective predetermined intervals in a circumferential direction rotatably piece by piece. Thereby, the respective balls 60 can be rolled between the inner ring raceway 20a and the outer ring raceway 40a without bringing the respective rolling faces into contact with each other. As a result, an increase in a rotational resistance, a damage of a seizure or the like by producing a friction by bringing the respective balls 60 into contact with each other can be prevented.

As the cage 80, a so-to-speak inclined type cage or a crown type cage, or other machine or press type of a cage can arbitrarily be selected to apply. For example, the inclined type cage (machine type) 80 includes a main body portion 80m constituting a shape of a tapered circular cylinder in which either one side (as an example, left side in the drawing) is smaller than other side (as an example, right side of the drawing) in a diameter thereof. Further, the main body portion 80m is formed with the pockets 80p for rotatably retaining the respective balls 60 piece by piece on respective inner sides at respective predetermined intervals (for example, equal intervals) in the circumferential direction. Further, there is an inclined type cage (punch type) having a structure provided with a side face portion connected to a small diameter side end portion of a main body portion thereof, extended in an inner ring direction, present between the two raceway rings 20 and 40 and covering a space of installing the respective balls 60.

Meanwhile, when a pitch circle diameter of the respective balls 6 (a diameter of an imaginary circle connecting center points of respective balls 60) is designated as dm [mm] and a rotational number per 1 minute of the ball bearing is designated as n [min⁻¹], a rotational speed characteristic value constituted by multiplying the pitch circle diameter dm by a value of the rotational number N (dm N value: dmN=dm×N) is known as a kind of an index of determining a usability in consideration of a rotational number and a size of a ball bearing. That is, there is frequently a case in which the dmN value of a rotation support portion is utilized as one of indexes when a durability of the ball bearing incorporated to the rotation support portion is taken into a consideration (reduce damage).

For example, in a case of a machining apparatus, a rotation shaft (main shaft) which is rotated at a high speed as in a spindle motor of a machine tool or the like, there is frequently a case in which a ball bearing used for supporting the rotating shaft is operated in a state in which dmN value thereof exceeds a million. In contrast thereto, in a case of a general industrial machine a rotating shaft of which is not rotated as fast as the above-described spindle motor as in, for example, a pump apparatus, a compressor apparatus or the like, there is frequently a case in which a ball bearing used for supporting the rotating shaft is operated by a dmN value equal to or smaller than five hundred thousands.

In a case of a ball bearing used under a comparatively low speed operating environment of the dmN value equal to or smaller than five hundred thousands in this way, a necessity of taking an influence of a centrifugal force applied to the respective balls 60 into consideration is comparatively low. Therefore, an allowable load capacity thereof can be increased by increasing a number of the respective balls 60 incorporated between the inner ring raceway 20a and the outer ring 40a, or increasing a diameter (outer diameter) of the respective balls. However, in a case of a ball bearing, a size thereof is determined by a standard, and therefore, a number of the respective balls cannot be increased or the diameter of the respective balls 60 cannot be increased thoughtlessly. That is, in order to realize a ball bearing having a high load capacity, it is important how the number of the respective balls 60 incorporated between the inner ring raceway 20a and the outer ring raceway 40a is increased, or the diameter of the respective balls 60 is increased in a limited bearing size, in other words, in a limited space of an inner portion of the ball bearing.

With regard to such a request, for example, Patent Reference 1 describes a constitution of a ball bearing capable of incorporating more balls, or incorporating a ball having a larger diameter in a limited space. In the case of the ball bearing having a structure described in the cited reference 1, as shown by FIG. 7, when the diameter of the respective balls 60 is designated as Da, an axial width of the angular ball bearing X (a distance in a left and right direction of FIG. 7) is designated as B4, a sectional height of the angular ball bearing X {(outer ring outer diameter−inner ring inner diameter)/2} is designated as H4, and a distance between centers of the respective balls 60 adjacent to each other in a circumferential direction is designated as L4 (not illustrated), dimensions of respective portions thereof are restricted such that all of relationships of 0.60≦Da/H4≦0.75, and 0.58≦Da/B4≦0.85, and 1.03≦L4/Da≦1.25 are satisfied.

In the case of the structure described in Patent Reference 1, by restricting the dimensions of the respective portions as described above, when compared by the angular ball bearing X having the same size (same dimensions in inner and outer diameters, a width of a bearing) more of the balls 60 can be incorporated between the inner ring raceway 20a and the outer ring raceway 40a without bringing the respective balls adjacent to each other into contact with each other. Similarly, the inner space between the inner ring raceway 20a and the outer ring raceway 40a can further be increased and the diameter of the respective balls 60 can be increased. As a result, the allowable load capacity of the angular ball bearing X can be increased, that is, high load capacity formation of the angular ball bearing X can be achieved.

Further, also with regard to a dimension and a shape of the inclined type cage 80, the dimension and the shape are restricted as follows. That is, when an outer diameter of a small diameter side end portion (left end portion of FIG. 7) of the inclined type cage 80 is designated as D4, an inner diameter of a large diameter side end portion (a right end portion of the drawing) is designated as SD4, and a pitch circle diameter is designated as dm, shapes and dimensions of respective portions are restricted such that all of D4 dm+0.10×Da, and SD4≦dm−0.05×Da are satisfied. The inclined type cage 80 can retain more of the balls 60 while sufficiently ensuring strength thereof when incorporated to a ball bearing of the same size by constituting such dimensions and shapes.

As described above, according to the constitution of the angular type ball bearing described in Patent Reference 1, the allowable load capacity can effectively be increased by effectively utilizing a limited space. However, there is a room for an improvement in view of a change in an environment surrounding an industry in recent years, specifically, in view of a request for energy conservation for protecting a global environment. That is, it is requested to reduce a rotational torque (particularly, dynamic torque) of a ball bearing assembled to a rotation support portion of each industrial machine as less as possible.

As a method of reducing a rotational torque of a ball bearing, conventionally, there is known a method of using a lubricant of grease or the like supplied to a rolling contact portion of the ball bearing having a low viscosity, or restraining an amount of feeding lubricant to be small. Although rotational torque of a ball bearing can be reduced to some degree by such a method, it is difficult to form a sufficiently strong oil film at the rolling contact portion, which is disadvantageous in view of ensuring a durability of the ball bearing. Therefore, there is a limit in reducing the rotational torque by low viscosity formation of lubricant of grease or the like, reducing an amount of feeding the lubricant or the like.

In contrast thereto, Patent References 2 through 5 describe that by reducing a pitch circle diameter of respective balls in comparison with an outer diameter and an inner diameter of a ball bearing, a rotational torque of the ball bearing is reduced. Further, Patent Reference 2 thereamong describes that rotational torque of a ball bearing is reduced by increasing radii of curvature of sectional shapes of an inner ring raceway of an inner ring outer peripheral face and an outer ring raceway of an outer ring inner peripheral face and by reducing contact ellipses formed at rolling contact portions of the two raceways and rolling faces of the respective balls. However, any of Patent References 2 through 5 describes with regard to a structure constituting an object by an angular type ball bearing and capable of sufficiently reducing a rotational torque while ensuring a durability.

Patent Reference 1: JP-A-2005-61508

Patent Reference 2: JP-A-2001-90736

Patent Reference 3: JP-A-63-289318

Patent Reference 4: JP-A-56-101417

Patent Reference 5: JP-A-10-37951

### DISCLOSURE OF THE INVENTION

### Problems that the Invention is to Solve

In view of the above-described situation, the invention has been made to provide an angular ball bearing capable of reducing a rotational torque without sacrificing durability.

Further, the invention achieves to realize an angular ball bearing capable of not only reducing a rotational torque but achieving high load capacity formation by respectively setting dimensions of an inner ring and an outer ring and respective balls to predetermined relationships as necessary, incorporating more balls between an inner ring raceway provided at an inner peripheral face of the inner ring and an outer ring raceway provided at an inner peripheral face of the outer ring and increasing a diameter of the ball.

### Means for Solving the Problems

In order to resolve the above-described problem, an angular ball bearing of the invention includes an inner ring and an outer ring arranged concentrically with each other and relatively rotatably, a plurality of balls rotatably incorporated between an inner ring raceway formed at an outer peripheral face of the inner ring and an outer ring raceway formed at an inner peripheral face of the outer ring, and a cage rotatably retaining the respective balls. Further, at least one raceway of the inner ring raceway and the outer ring raceway is made to constitute a raceway of an angular type (constituting one side thereof by a counter-bore). Further, the raceway one side of which is constituted by the counter-bore may be either one raceway of the inner ring raceway and the outer ring raceway, or may constitute the both raceways.

Particularly, according to the angular ball bearing of the invention, when an outer diameter of the outer ring is designated as D, an inner diameter of the inner ring is designated as d and a pitch circle diameter of the respective balls is designated as dm, a relationship of (D+d)/2×0.85≦dm≦(D+d)/2×0.97 is satisfied.

When the above-described angular ball bearing of the invention is embodied, preferably, as a second aspect of the invention, dimensions of the respective balls and the inner ring and the outer ring are restricted such that when a diameter of the respective balls is designated as Da, an axial width of the ball bearing (the inner ring and the outer ring constituting the ball bearing) is designated as B, and a distance between centers of the respective balls adjacent to each other in a circumferential direction is designated as L, and a sectional height of the ball bearing calculated by a relationship of H=(D−d)/2 is designated as H, all of relationships of 0.60≦Da/H≦0.75, and 0.58≦Da/B≦0.85, and 1.03Da≦L≦1.25Da are satisfied.

Further, preferably, as a third aspect of the invention, an angle of contact α of the respective balls is set to 15° through 45°. That is, each of the balls is brought into contact with the inner ring raceway and the outer ring raceway by respective one points, or by 2 points for each of the balls, further, when the angle of contact α is constituted by an angle made by an action line (of a load supported by the respective balls) connecting the two points and a plane orthogonal to a center axis of the ball bearing, dimensions and shapes of respective portions are restricted to satisfy a relationship of 15°<α<45°.

Further, preferably, as a fourth aspect of the invention, dimensions and shapes of respective portions are restricted such that when a radius of curvature of a sectional shape of the outer ring raceway is designated as Re, a radius of curvature of a sectional shape of the inner ring raceway is designated as Ri, and a diameter of each of the balls is designated as Da, Re/Da exceeds 0.52 and less than 0.58 and Ri/Da exceeds 0.52 and less than 0.56.

### ADVANTAGE OF THE INVENTION

In the case of the angular ball bearing of the invention having the above-described constitution, the pitch circle diameter of the respective balls is reduced in comparison with the outer diameter and the inner diameter of the ball bearing. Therefore, a rotational torque of the angular ball bearing can be reduced without changing a dimension of a space to be incorporated with the angular ball bearing. That is, a position of installing each of the balls is deviated from a middle portion in the diameter direction of the angular ball bearing to an inner diameter side. Therefore, as is apparent from a principle of a lever, a force required for rolling the respective balls is reduced and a reduction in the rotational torque can be achieved.

Further, according to the second aspect and the third aspect of the invention, while ensuring the diameter of the respective balls, more of the balls can be incorporated between the outer ring raceway formed at the outer peripheral face of the inner ring and the outer ring raceway formed at the inner peripheral face of the outer ring (either or both of an increase in the number of the balls and an increase in the diameter of the balls can be carried out), and high load capacity formation of the angular ball bearing can be achieved. Further, the angular ball bearing can be continued to rotate highly accurately over a long period of time.

Further, according to the fourth aspect of the invention, by reducing the contact ellipses formed at the rolling contact portions of the rolling faces of the respective balls and the inner ring raceway and the outer ring raceway, a friction loss based on spinning the respective contact ellipses can be reduced and the rotational torque can further be reduced.

### BRIEF DESCRIPTION OF THE DRAWINGS

FIG. 1 is a partial sectional view of an angular ball bearing showing a first example of an embodiment of the invention.

FIG. 2 is a diagram showing a relationship between a pitch circle diameter and a heat generating amount in operating.

FIG. 3 is a partial sectional view similar to FIG. 1.

FIG. 4 illustrates a partial sectional view (a) similar to FIGS. 1 and 3 and a partial sectional view (b) in a direction orthogonal thereto of an angular ball bearing showing a second example of the embodiment of the invention.

FIG. 5 is a partial sectional view of an angular ball bearing for explaining proper values of radii of curvature of sectional shapes of an outer ring raceway and an inner ring raceway.

FIG. 6 illustrates diagrams showing an influence of radii of curvature of sectional shapes of an outer ring raceway and an inner ring raceway effected on a heat generating amount in operating.

FIG. 7 is a partial sectional view showing a constitution example of a conventional angular ball bearing.

### DESCRIPTION OF REFERENCE NUMERALS AND SIGNS

2 inner ring
2a inner ring raceway
2c counter-bore
4a outer ring
4a outer ring raceway
4c counter-bore
6 ball
8 cage
8m main body portion
8p pocket
20 inner ring
20 a inner ring raceway
40 outer ring
40a outer ring raceway
60 ball
80 cage
80m main body portion
A1, A2, A3 angular ball bearings
X angular ball bearing

### BEST MODE FOR CARRYING OUT THE INVENTION

### First Example of Embodiment

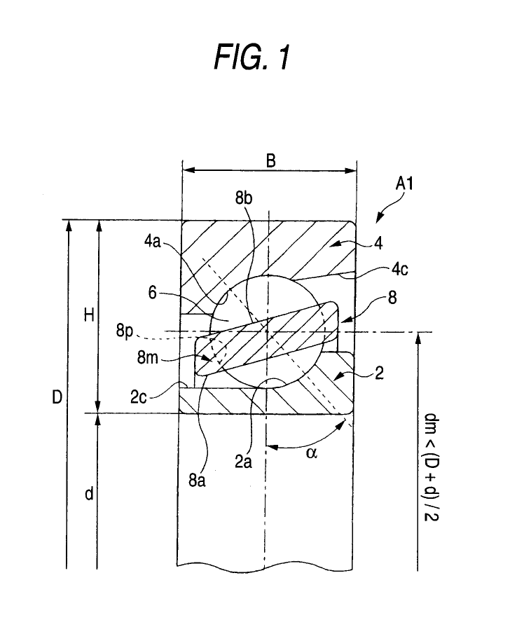

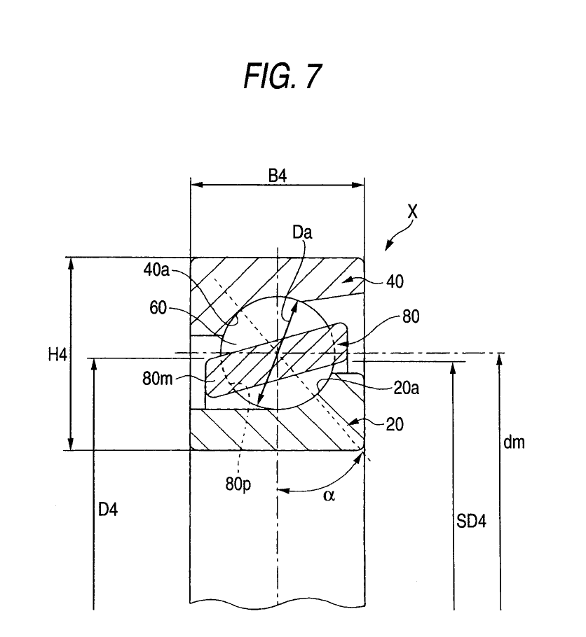

FIG. 1 shows a first example of an embodiment of the invention. Further, a size, ratios of dimensions of respective portions and the like of an angular ball bearing A1 in a case of embodying the invention are arbitrarily set in accordance with various kinds of standards and the like, and therefore, these are not particularly limited. In this example, as an example, there is assumed a case in which all of an outer diameter of an outer ring 4 (bearing outer diameter D), an inner diameter (bearing inner diameter) d of an inner ring 2, and a width B in an axial direction are respectively set to dimensions the same as those of the conventional angular ball bearing X shown in FIG. 7 (the same sizes and the same dimension ratios) and a constitution thereof will be explained as follows.

The angular ball bearing A1 of the first example of the embodiment of the invention shown in FIG. 1 includes an inner ring 2 and an outer ring 4 arranged relatively rotatably, a plurality of balls 6 rotatably incorporated between an inner ring raceway 2a formed at an outer peripheral face of the inner ring 2 and an outer ring raceway 4a formed at an inner peripheral face of the outer ring 4, and a cage 8. The respective balls 6 are retained rotatably in pockets 8p at a plurality of portions of the cage 8 with equal intervals in a circumferential direction.

The inner ring 2 is cut a shoulder portion of the inner ring raceway 2a such that one side in an axial direction (left side of FIG. 1) of the outer peripheral face is more thin-walled than other side in the axial direction (right side of FIG. 1) to constitute the portion as a counter-bore 2c. In the case of this example, the counter-bore 2c is constituted by a shape of a cylindrical face of which outer diameter in the axial direction remains unchanged. On the other hand, the outer ring 4 is cut a shoulder portion of the outer ring raceway 4a such that in both end portions in the axial direction of the inner peripheral face, an end portion on a side opposed to the counter-bore 2c of the inner ring 2 (right end portion of FIG. 1) is more thin-walled than a side of the counter-bore 2c (left end portion of FIG. 1) to constitute the portion as a counter-bore 4c. In the case of this example, the counter-bore 4c is constituted by an inclined recessed face in a shape of a partial cone inclined in a direction in which the more proximate to an end face in the axial direction, the larger the inner diameter.

Further, shapes and dimensions or the like of the two counter-bores 2c and 4c formed at peripheral faces of the inner ring 2 and the outer ring 4 are arbitrarily set in accordance with dimensions or the like of the inner ring 2 and the outer ring 4, and are not limited to shapes and sizes as illustrated. For example, other than the above-described constitutions shown in FIG. 1, the counter-bore 2c of the outer peripheral face of the inner ring 2 may be constituted by a projected face in a shape of a partial cone inclined in a direction in which the more proximate to the end face of the angular ball bearing A1, the smaller the outer diameter, and the counter-bore 4c of the inner peripheral face of the outer ring 4 may be constituted by a shape of a cylindrical face in which an inner diameter thereof remains unchanged in the axial direction. Further, although in the case of structure shown in FIG. 1, both of the inner ring 2 and the outer ring 4 are constituted by the shapes of the one side counter-bores, only the raceway ring of the either one of the inner ring 2 and the outer ring 4 may be constituted by the shape of the one side counter-bore. In this case, a deep groove type raceway is formed at a peripheral face of other raceway ring.

Further, materials of the inner ring 2, the outer ring 4 and the respective balls 6 are not particularly limited. Pertinent materials are selected to use in accordance with a use or the like of the angular ball bearing A1, and in accordance with strength, rigidity, heat resistance, corrosion resistance and the like requested. For example, as materials of the inner ring 2 and the outer ring 4, metal materials of high carbon chromium bearing steel, carburized bearing steel, stainless bearing steel and the like can be used. Further, as a material of the respective balls 6, in addition to the metal materials, a material selected from nonmetallic materials of a synthetic resin (high rigidity high function resin), a ceramic and the like can also be used.

Further, in the case of the illustrated example, the cage 8 includes a main body portion 8m in a shape of a partial conical cylinder inclined in a direction in which a diameter thereof on a side of the counter-bore 4c of the inner peripheral face of the outer ring 4 is larger than a diameter thereof on a side of the counter-bore 2c of the outer peripheral face of the inner ring 2. Further, a middle portion in the axial direction of the main body portion 8m is formed with a plurality of pockets 8p at predetermined intervals (at equal intervals) in a circumferential direction. The cage 8 is constituted as a machined cage of which respective pockets 8p are formed by machining the middle portion in the axial direction in the shape of the conical cylinder. Further, the respective balls 6 are rotatably retained in the respective pockets 8p piece by piece for the respective pockets 8p. The cage 8 and the respective balls 6 are incorporated to between the inner ring raceway 2a formed at the outer peripheral face of the inner ring 2 and the outer ring raceway 4a formed at the inner peripheral face of the outer ring 4.

Further, in the case of the illustrated example, an axial dimension of the cage 8 (a width in a left and right direction of FIG. 1) is constituted by a predetermined dimension less than an axial dimension (a width in the same direction) of the angular ball bearing A1 (the inner ring 2 and the outer ring 4 constituting the bearing). Further, both end faces in the axial direction of the cage 8 are made to be presented at positions recessed from the both end faces in the axial direction of the angular ball bearing A1. Further, in the case of the example, a position in the diameter direction of the cage 8 is restricted by so-to-speak ball guide based on an engagement of an inner face of each pocket 8p and a rolling face of each ball 6. In other words, an inner peripheral face 8a and an outer peripheral face 8b of the main body portion 8m are not brought into contact with either face of the outer peripheral face of the inner ring 2 and the inner peripheral face of the outer ring 4. However, when the invention is embodied, a method of guiding (restricting a position in a diameter direction of) the cage 8 is not limited to the ball guide. For example, the guide system may be of an inner ring guide type in which the large diameter side end portion of the inner peripheral face 8a of the main body portion 8m is brought into contact with a groove shoulder of the outer peripheral face of the inner ring 2 (a shoulder portion of the track face 2a) or an outer ring guide type in which a small diameter side end portion of the outer peripheral face 8b of the main body portion 8m is brought into contact with a groove shoulder of the inner peripheral face of the outer ring 4 (shoulder portion of the track face 4a) to be guided to rotate. In either of the structures, the cage 8 is rotated in a ring-like shape between the outer peripheral face of the inner ring 2 and the inner peripheral face of the outer ring 4 along with the respective balls 6 in a state of respectively retaining the respective balls 6 piece by piece in the respective pockets 8p.

Further, material of the cage 8 is not particularly limited but a pertinent material is selected to be used in accordance with strength, rigidity, heat resistance, corrosion resistance or the like requested for the cage 8. For example, as the material of the cage 8, metal material of brass species alloy of high strength brass or the like, ferrous alloy of structural carbon steel or the like can pertinently be selected to be used. Further, other than such a metal material, the cage may be made of a synthetic resin of polyamide or the like. Further, when the cage 8 is made of a synthetic resin of polyamide or the like, the cage 8 can integrally be molded by subjecting the synthetic resin to injection molding. Further, when the cage 8 is made of a synthetic resin, strength of the cage 8 can also be increased by mixing, for example, fiber of glass fiber, carbon fiber or the like or reinforcement material of whisker or the like to the base material (synthetic resin) of polyamide or the like as an additive as necessary.

In the case of the example, in the angular ball bearing A1 having the above-described basic constitutions, dimensions of respective portions are restricted as follows. That is, when the outer diameter (bearing outer diameter) of the outer ring 4 is designated as D, the inner diameter (bearing inner diameter) of the inner ring 2 is designated by d, and pitch circle diameter of the respective balls (a diameter of an imaginary circle connecting center points of the respective balls) is designated as dm, the dimensions of the respective portions are restricted to satisfy a relationship of dm<(D+d)/2. Therefore, whereas in the case of the conventional angular ball bearing shown in FIG. 7, the pitch circle of the respective balls 6 (an imaginary circle connecting center points of the respective balls 60) is set to a center position in the diameter direction of an outer diameter position of the outer ring 40 (the outer diameter position of the angular ball bearing X) and an inner diameter position of the inner ring 20 (the inner diameter position of the angular ball bearing X), in the case of the angular ball bearing A1 of the example shown in FIG. 1, the pitch circle of the respective balls 6 is set to a position of the diameter direction center of the outer diameter position and the inner diameter position of the angular ball bearing A1 deviated to the side of the inner ring 2. That is, in the case of the angular ball bearing A1 of the example, by making a thickness in the diameter direction of the outer ring 4 larger than a thickness in the diameter direction of the inner ring 2 (by increasing the thickness in the diameter direction of the outer ring 4 by an amount of reducing the thickness in the diameter direction of the inner ring 2), while the outer diameter dimension and the inner diameter dimension of the angular ball bearing A1 are made to be the same as those of the conventional angular ball bearing X, the pitch circle diameter dm of the respective balls 6 is set to be smaller.

In the case of the angular ball bearing A1 of the example, as described above, the diameter dm of the pitch circle of the respective balls 6 is made to be smaller than that of the conventional structure, and therefore, a moment required in relatively rotating the inner ring 2 and the outer ring 4 in order to roll the respective rolls 6 can be reduced. As a result, a rotational torque (static torque and dynamic torque) in rotating (in starting and in rotating) the angular ball bearing A1 can be reduced. According to the angular ball bearing A1 of the example, without changing the size of the conventional angular ball bearing X, that is, while maintaining the outer diameter of the outer ring 4 (bearing outer diameter) and the inner diameter of the inner ring 2 (bearing inner diameter) constituting the angular ball bearing A1 the same as the dimensions of the inner ring 20 and the outer ring 40 constituting the angular ball bearing X at the same positions, only the pitch circle diameter dm of the respective balls 6 is set to be small. Therefore, the angular ball bearing A1 of the example can effectively reduce the rotational torque by replacing the conventional angular ball bearing X as it is (without changing a dimension of a portion to be incorporated with the angular ball bearing or the like at all).

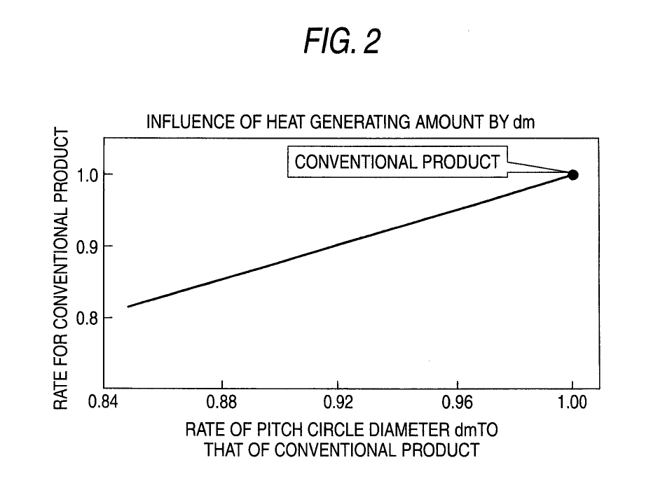

As shown by FIG. 2, the smaller the pitch circle diameter dm of the respective balls 6, the smaller the rotational torque (loss) and the smaller the heat generated in accordance with the loss. Further, FIG. 2 shows a result calculated with regard to an influence of a size of the pitch circle diameter dm effected on a heat generating amount based on the loss with regard to the angular ball bearing having the outer diameter D of 120 mm, the inner diameter d of 55 mm, the width B in the axial direction of 29 mm, and the radii of curvature of the sectional shapes of the inner ring raceway and the outer ring raceway 0.52 time as much as the diameter of the ball. The abscissa indicates a rate of sizes of dm when the size of the conventional structure of dm=(D+d)/2 is set to 1, and the ordinate indicates a rate of heat generating amounts when the heat generating amount of the conventional structure is set to 1, respectively. As is apparent from FIG. 2 in this way, the smaller the pitch circle diameter dm of the respective balls 6, the more reduced the rotational torque (the heat generating amount based thereon) of the angular ball bearing.

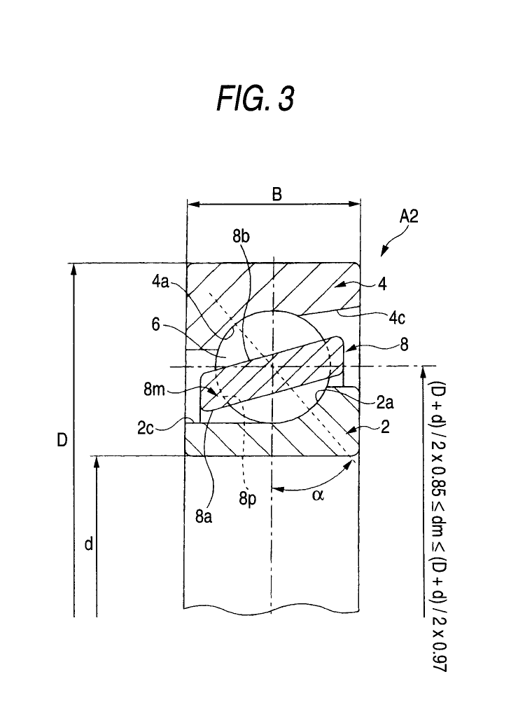

Although in this way, the rotational torque of the angular ball bearing can be reduced by the amount of reducing the pitch circle diameter dm of the respective balls 6, in order to achieve sufficient operation and effect, as shown by FIG. 3, the pitch circle diameter dm is set to the pitch circle diameter dm of the conventional structure multiplied by 0.85 through 0.97. That is, the dimensions of the respective portions of the angular ball bearing A1 are restricted to satisfy a relationship of (D+d)/2×0.85≦dm≦(D+d)/2×0.97. Further, also in a case of an angular ball bearing A2 shown in FIG. 3, the outer diameter D of the outer ring 4 (bearing outer diameter), the inner diameter d of the inner ring 2 (bearing inner diameter), and the width B in the axial direction are set to be the same as the outer diameters, the inner diameters, and the widths of the angular ball bearing A1 shown in FIG. 1 and the angular ball bearing X shown in FIG. 7. Further, also the dimension of the respective balls 6 and the shape and the dimension of the cage 8 constituting the angular ball bearing A2 are made to be the same as those of the angular ball bearing A1 shown in FIG. 1.

In the case of the example, as described above, by setting the pitch circle diameter dm of the respective balls 6 to a proper value (a predetermined value in the above-described range), the rotational torque can be reduced without reducing the allowable load capacity of the angular ball bearing A2. That is, by setting the pitch circle diameter dm of the respective balls 6 equal to or smaller than (D+d)/2×0.97, the rotational torque of the angular ball bearing A2 can clearly be reduced in comparison with that of the angular ball bearing having the same size as in the conventional angular ball bearing X shown in FIG. 7. However, when the pitch circle diameter dm of the respective balls 6 is made to be smaller than (D+d)/2×0.85, the diameter of the respective balls 6 needs to be reduced, or the thickness in the diameter direction of the inner ring 2 is excessively reduced, and it is difficult to ensure the durability of the inner ring 2. At any rate, when the pitch circle diameter dm is excessively reduced {dm<(D+d)/2×0.85}. the allowable load capacity of the angular ball bearing A2 is reduced. Hence, the pitch circle diameter dm of the respective balls 6 is ensured to be equal to or larger than (D+d)/2×0.85. Further, as described above, the rotational torque is effectively reduced without reducing the allowable load capacity of the angular ball bearing A2.

### Second Example of Embodiment

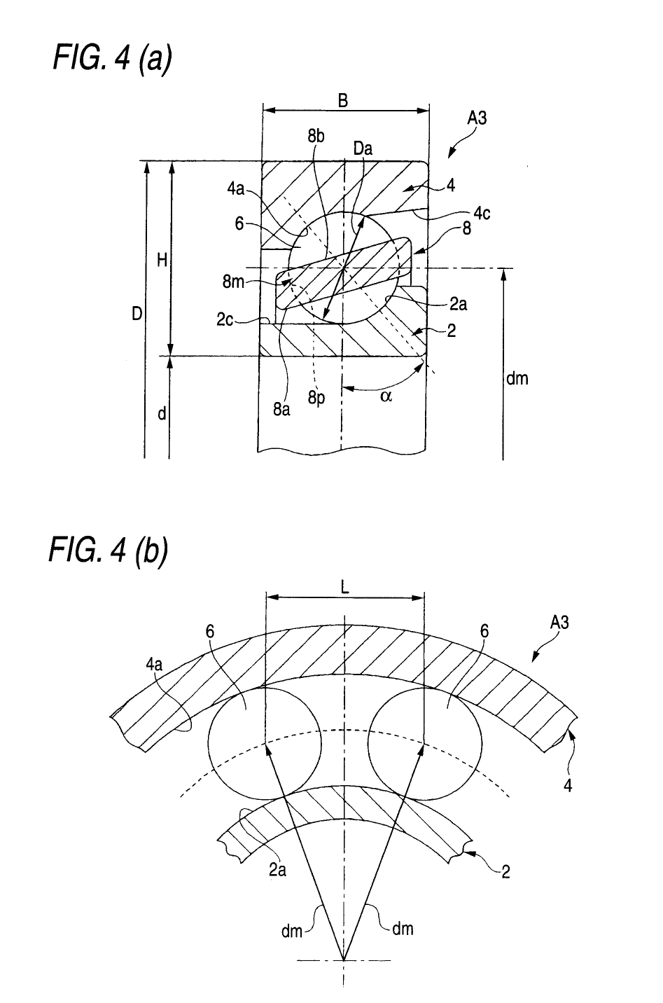

In a case of an angular ball bearing A3 shown in FIG. 4, in addition to constitutions of the angular ball bearings A1 (FIG. 1), and A2 (FIG. 3) of the first example of the above-described embodiment (relationships among dimensions of the inner ring 2, the outer ring 4 and the respective balls 6 for restraining the pitch circle diameter dm), a relationship among the diameter Da of the respective balls 6, the axial width of the angular ball bearing A3, the distance L between centers of the respective balls, and the sectional height of the angular ball bearing A3 is properly restricted. Further, the section height H of the angular ball bearing A3 thereamong is calculated by H=(D−d)/2 from the outer diameter D and the inner diameter d of the angular ball bearing A3. Further, the distance L between centers refers to a shortest distance between centers of a pair of the balls 6 adjacent to each other in the circumferential direction. In the case of the example, the respective dimensions are restricted to satisfy all of relationships of 0.60≦Da/H≦0.75, and 0.58≦Da/B≦0.85, and 1.03Da≦L≦1.25Da.

Further, in the angular ball bearing A3, all of the outer diameter (bearing outer diameter) D of the outer ring 4, the inner diameter (bearing inner diameter) d of the inner ring 2, and the width B in the axial direction are made to be the same as dimensions of corresponding portions of the angular ball bearing A1 shown in FIG. 1, the angular ball bearing A2 shown in FIG. 2, and the conventional angular ball bearing X shown in FIG. 7. Further, also with regard to the dimension of the respective balls 6 constituting the angular ball bearing A3 and the shape and the dimension of the cage 8, the dimensions are made to be the same as those of the angular ball bearing A1 shown in FIG. 1 and the angular ball bearing A2 shown in FIG. 3.

In the case of the angular ball bearing A3 of the example restricting the dimensions of the respective portions to establish the above-described dimension relationships, a space of incorporating the cage 8 can be ensured in the ring-like space between the outer peripheral face of the inner ring 2 and the inner peripheral face of the outer ring 4, and the wall thickness of the cage 8 can be ensured. Further, a size (inner diameter) of the respective pockets 8p provided at the cage 8 can be ensured and the diameter of the respective balls 6 retained in the respective pockets 8p can be ensured. Therefore, the strength of the cage 8 incorporated to the bearing of the same size (for example, the angular ball bearings A1 and A2 illustrated in FIGS. 1 and 3) can be ensured, or the diameter of the respective balls 6 can be ensured and the allowable load capacity of the angular ball bearing A3 can be increased.

In the case of the example, by restricting the section height H and the diameter Da of the respective balls 6 and the width B in the axial direction to satisfy the relationships of 0.60≦Da/H≦0.75, and 0.58≦Da/B≦0.85 as described above, a space to be incorporated by the cage 8 can be ensured in the limited ring-like space.

Further, the distance L between centers of the respective balls 6 adjacent to each other in the circumferential direction needs to be larger than the diameter Da of the respective balls 6. That is, when the distance L between centers thereof is smaller than the diameter Da (L/Da<1), the respective balls 6 adjacent to each other in the circumferential direction overlap each other in the ring-like space (actually, cannot be incorporated). Further, when the distance L between centers thereof is slightly larger than the diameter Da (L/Da is slightly larger than 1), space for incorporating the cage 8 (for passing a pillar portion of the cage 8) cannot sufficiently be ensured between the respective balls 6 adjacent to each other in the circumferential direction. In contrast thereto, when the distance L between centers thereof is excessively larger than the diameter Da (L/Da is considerably larger than 1), the number of the balls 6 which can be incorporated into the ring-like space is reduced, and the allowable load capacity of the angular ball bearing A3 is reduced.

Hence, in the case of the example, the distance L between centers thereof and the diameter Da of the respective balls 6 are restricted to satisfy the relationship of 1.03Da≦L≦1.25Da. Further, the rotational torque of the angular ball bearing A3 is made to be able to effectively be reduced such that the pitch circle diameter dm of the respective balls 6 can effectively be reduced while ensuring the strength of the cage 8 and the number of the respective balls 6. Further, volume of a portion of the ring-like space constituting an inner space of the angular ball bearing A3 capable of installing the cage 8 can sufficiently be ensured within a range of a size determined by various kinds of standards. As a result, the cage 8 can be thick-walled, the strength of the cage 8 can be increased, and the allowable load capacity of the angular ball bearing A3 can be ensured.

### INDUSTRIAL APPLICABILITY

When the invention is embodied, the angle of contact a of the respective balls 6 is a value arbitrarily set in accordance with an object of using, a condition of using or the like of the angular ball bearings A1, A2 and A3 of the respective examples and is not particularly limited. Preferably, the angle of contact α is set to a predetermined value larger than 15° and smaller than 45° (15°<α<45′). Further, as is well known in a technical field of a rolling bearing, as described above, the angle of contact α refers to the angle made by the action line connecting the centers of the contact ellipses formed at the rolling contact portions of the rolling face of each ball 6 and the inner ring raceway 2a and the outer ring raceway 4a, and the plane orthogonal to the center axes of the angular ball bearings A1, A2 and A3.

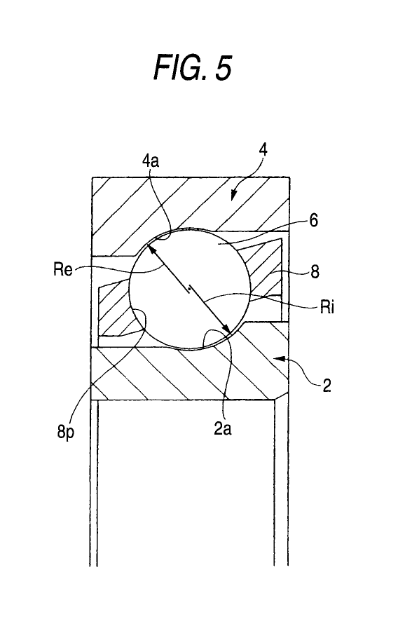

Similarly, also the radii of curvature of the sectional shapes of the inner ring raceway 2a and the outer ring raceway 4a (so-to-speak groove R) are values arbitrarily set in accordance with an object of using, conditions of using or the like of the angular ball bearings A1, A2 and A3 of the respective examples and are not particularly limited. However, in correspondence with the object of the invention of realizing the angular ball bearing having the high load capacity and the low load rotational torque, it is preferable to restrict a radius of curvature Re of the sectional shape of the outer ring raceway 4a and Ri of the sectional shape of the inner ring raceway 2a (refer to FIG. 5) to ranges shown below in view of relationships with the diameter Da of the respective balls 6.

0.52<Re/Da<0.58

0.52<Ri/Da<0.56

When the radii of curvature Re and Ri of the sectional shapes of the two tracks 4a and 2a are restricted as descried above, sufficient low torque formation can be achieved and heat generation can be restrained.

That is, when the radii of curvature Re and Ri of the sectional shapes of the outer ring raceway 4a and the inner ring raceway 2a are increased to satisfy the above-descried conditions, the contact ellipses formed at the rolling contact portions of the rolling faces of each ball 6 and the outer ring raceway 4a and the inner ring raceway 2a are reduced, low heat generation formation of the angular ball bearing can be achieved by reducing a rolling resistance (spin loss accompanied by sliding friction) produced at the contact ellipse portion in being rotated.

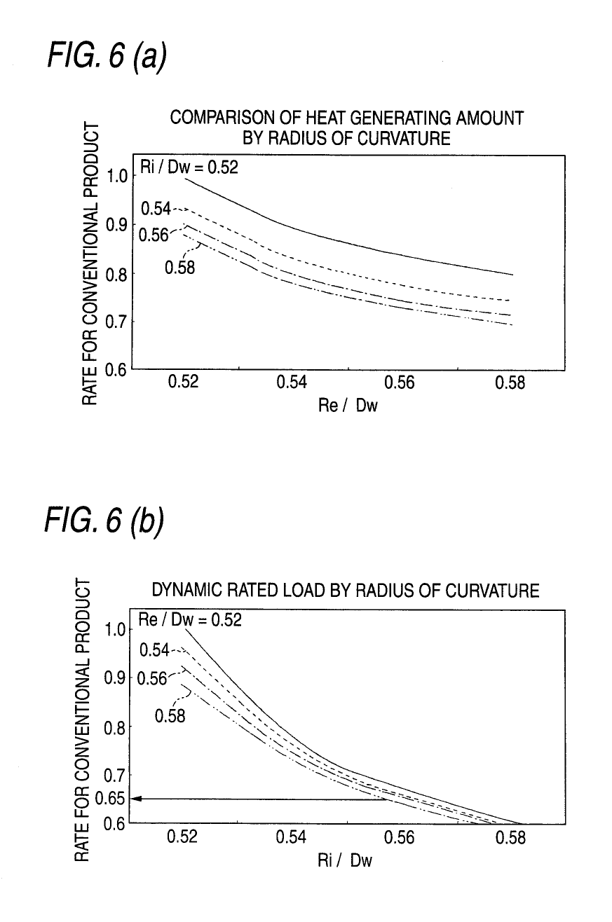

FIG. 6 shows a result of a calculation carried out in order to know an influence of ratios of the radii of curvature Re and Ri of the sectional shapes of the outer ring raceway 4a and the inner ring raceway 2a as compared with the diameter Da of the respective balls 6 effected on the heat generating amount of the angular ball bearing. As a condition of the calculation, the following angular ball bearing is assumed.

outer diameter D: 120 mm

inner diameter d: 55 mm

axial direction width B: 29 mm

materials of inner ring, outer ring, ball: SUJ2

inner ring rotational speed: 3600 min⁻¹

lubricant: VG68

Under the above-described condition, the radii of curvature Re and Ri of the sectional shapes of the outer ring raceway 4a and the inner ring raceway 2a are changed, an influence of the changed radii of curvature effected on the heat generating amount or a dynamic rated load is calculated, and a result thereof is shown in FIGS. 6(a) and (b). Results thereof are shown in FIG. 6(a) and (b). FIG. 6(a) thereof shows a fluctuation in the heat generating amount when the radii of curvature Re and Ri of the sectional shapes of the two tracks 4a and 2a are changed, and FIG. 6(b) shows a fluctuation in a dynamic rated load when the radii of curvature Re and Ri of the sectional shapes of the two tracks 4a and 2a are changed, respectively. Further, the abscissa of FIG. 6 shows Re/Da or Ri/Da, and the ordinate shows a rate of the heat generating amount or the dynamic rated load when the structure of Re/Da=Ri/Da=0.52 is set to 1. As is apparent from FIG. 6(a), the larger the respective radii of curvature Re and Ri, the more reduced the rotational torque (heat generating amount based thereon) of the angular ball bearing.

However, as is apparent from FIG. 6(b), when the respective radii of curvature Re and Ri are excessively increased, the contact ellipses are made to be excessively small, face pressures at the contact ellipse portions are excessively increased, the dynamic rated load of the angular ball bearing is reduced, and the durability of the angular ball bearing is deteriorated. Hence, the respective radii of curvature Re and Ri are restricted to a range in which Re/Da exceeds 0.52 and less than 0.58 and Ri/Da exceeds 0.52 and less than 0.56.

That is, in the relationship between the respective radii of curvature Re and Ri and the diameter Da of the respective balls 6, when values of Re/Da and Ri/Da are excessively increased, the contact ellipse are reduced and the dynamic rated load is reduced. Particularly, with regard to the inner ring raceway 2a the shape in the circumferential direction of which is constituted by the projected circular arc, in comparison with the outer ring raceway 4a constituting the recessed circular arc, degree of reducing the contact ellipse in accordance with an increase in the radius of curvature is significant and a reduction in the dynamic rated load in accordance with an increase in the value of Ri/Da is significant.

Hence, when the inventor carries out a rolling fatigue life of the bearing of the above-described specification under a load condition of using a general pump as a rotational mechanical apparatus incorporated with the angular ball bearing, target life is not satisfied in a case of Re/Da=0.58 and Ri/Da=0.56. Hence, an upper limit value of the ratio Re/Da is made to be less than 0.58 and an upper limit value of the ratio Ri/Da is set to be less than 0.56.

Further, the application is based on Japanese Patent Application (Japanese Patent Application No. 2006-228725) filed on Aug. 25, 2006 and Japanese Patent Application (Japanese Patent Application No. 2007-209308) filed on Aug. 10, 2008 and a content thereof is incorporated herein by reference.

1. An angular ball bearing comprising:
an inner ring and an outer ring arranged concentrically with each other and relatively rotatably;
a plurality of balls rotatably incorporated between an inner ring raceway formed at an outer peripheral face of the inner ring and an inner peripheral face of the outer ring; and
a cage which rotatably retaining the respective balls,
wherein at least one of the inner ring raceway and the outer ring raceway is made to constitute an angular raceway,
wherein when an outer diameter of the outer ring is designated as D, an inner diameter of the inner ring is designated as d and a pitch circle diameter of the respective balls is designated as dm, a relationship of (D+d)/2×0.85≦dm≦(D+d)/2×0.97 is satisfied.

2. The angular ball bearing according to claim 1, wherein
when a diameter of the respective balls is designated as Da, an axial width of the ball bearing is designated as B, a distance between centers of the respective balls adjacent to each other in a circumferential direction is designated as L, and a sectional height of the ball bearing calculated by a relationship of H=(D−d)/2 is designated as H, all of relationships of 0.60≦Da/H≦0.75, and 0.58≦Da/B≦0.85, and 1.03Da≦L≦1.25Da are satisfied.

3. The angular ball bearing according to claim 1, wherein
when each of the balls is brought into contact with the inner ring raceway and the outer ring raceway respectively by 1 points thereof, that is, the respective balls has 2 contact points each, and an angle of contact constituting an angle made by an action line connecting the two contact points and a plane orthogonal to a center axis of the ball bearing is designated as α, a relationship of 15°<α<45° is satisfied.

4. The angular ball bearing according to claim 1, wherein when a radius of curvature of a sectional shape of the outer ring raceway is designated as Re, a radius of curvature of a sectional shape of the inner ring raceway is designated as Ri, and a diameter of each of the balls is designated as Da, Re/Da exceeds 0.52 and less than 0.58 and Ri/Da exceeds 0.52 and less than 0.56.
